(19) United States
(12) Patent Application Publication
(10) Pub. No.: US 2012/0200157 A1
(43) Pub. Date: Aug. 9, 2012

(54) ELECTRONIC APPARATUS, SYSTEM AND METHOD OF CONTROLLING ELECTRIC POWER SUPPLY, AND RECORDING MEDIUM STORING ELECTRIC POWER SUPPLY CONTROL PROGRAM

(76) Inventor: Noritada OHI, Saitama (JP)

(21) Appl. No.: 13/361,250

(22) Filed: Jan. 30, 2012

(30) Foreign Application Priority Data
Feb. 4, 2011 (JP) 2011-022552
Sep. 16, 2011 (JP) 2011-203540

(51) Int. Cl. H02J 9/00

(52) U.S. Cl. 307/23

(57) ABSTRACT

Electric power supply among a plurality of electronic devices in a system is controlled to improve efficiency in electric power conservation in the entire system. The system is provided with at least one electronic apparatus including a main power supply unit that supplies electric power from a main power source, a supplementary power source that supplies electric power being charged when electric power form the main power source is not supplied, and an interface that transmits or receives electric power to or from another electronic apparatus.

### CROSS-REFERENCE TO RELATED APPLICATIONS

This patent application is based on and claims priority pursuant to 35 U.S.C. §119 to Japanese Patent Application Nos. 2011-022552, filed on Feb. 4, 2011, and 2011-203540, filed on Sep. 16, 2011, in the Japan Patent Office, the entire disclosure of which is hereby incorporated herein by reference.

### BACKGROUND

1. Field

The present invention relates to an electronic apparatus provided with an interface that allows transmission or reception of electric power through a network, a system and method of controlling electric power supply, and a recording medium storing electric power supply control program.

2. Background

With the increased need for energy conservation, the recent image forming apparatus is provided with a function of switching its operation mode to an energy save mode when the apparatus is not in use, such that electric power is supplied to a selected portion of the image forming apparatus. For example, Japanese Patent Application Publication No. 2008-234061 describes an image forming apparatus provided with a power supply unit that supplies direct current (DC) electric power from a main power source such as a commercial alternating current (AC) power source, and a supplementary power source such as a secondary battery. In a stand-by mode or a normal operation mode, the secondary battery is charged with electric power supplied from the main power source. When the operation mode is switched to the energy save mode, electric power supplied from the main power source is cut off such that the secondary battery supplies electric power being charged to the selected portion of the image forming apparatus.

While this suppresses consumption of electric power in the energy save mode, if electric power charged in the secondary battery is used up, the image forming apparatus turns on a main power switch to start supplying electric power from the main power source. This may not necessarily improve efficiency in electric power conservation in the entire system in which a plurality of image forming apparatuses are provided.

Japanese Patent Application Publication No. 2007-26083 describes an information processing apparatus provided with an external interface having the communication function and the electric power supply function such as a universal serial bus (USB) interface and a local area network (LAN) interface. The information processing apparatus selects one of an AC power supply, a USB power supply, and a Power over Internet (PoE) supply, thus improving efficiency in electric power conservation. This may not necessarily improve efficiency in electric power conservation in the entire system, especially when the system includes the image forming apparatus supplied with electric power from the supplementary power source.

### SUMMARY

In view of the above, one aspect of the present invention is to provide a technique of controlling electric power supply from an electronic apparatus to another electronic apparatus to improve efficiency in electric power conservation in the entire system. At least one electronic apparatus in the system is provided with a main power supply unit that supplies electric power from a main power source, a supplementary power source that supplies electric power being charged when electric power from the main power source is not supplied, and an interface that transmits or receives electric power to or from another electronic apparatus. The system is provided with a function of controlling power transmission or reception in the system.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an illustration of an image processing system including an image forming apparatus, according to an example embodiment of the present invention;

FIG. 2 is a schematic block diagram illustrating a hardware structure of a selected portion of the image forming apparatus of FIG. 1;

FIG. 3 is a flowchart illustrating operation of transmitting electric power for charge to another image forming apparatus in the image processing system of FIG. 1, performed by the image forming apparatus of FIG. 1, according to an example embodiment of the present invention;

FIG. 4 is a flowchart illustrating operation of transmitting electric power for charge to another image forming apparatus in the image processing system of FIG. 1, performed by the image forming apparatus of FIG. 1, according to an example embodiment of the present invention;

FIG. 5 is an illustration of an example data structure of management information managed by the image forming apparatus of FIG. 1;

FIG. 6 is a flowchart illustrating operation of receiving electric power for charge from another image forming apparatus in the image processing system of FIG. 1, performed by the image forming apparatus of FIG. 1, according to an example embodiment of the present invention; and

FIG. 7 is an illustration of an example data structure of management information managed by the image forming apparatus of FIG. 1.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

[Image Processing System]

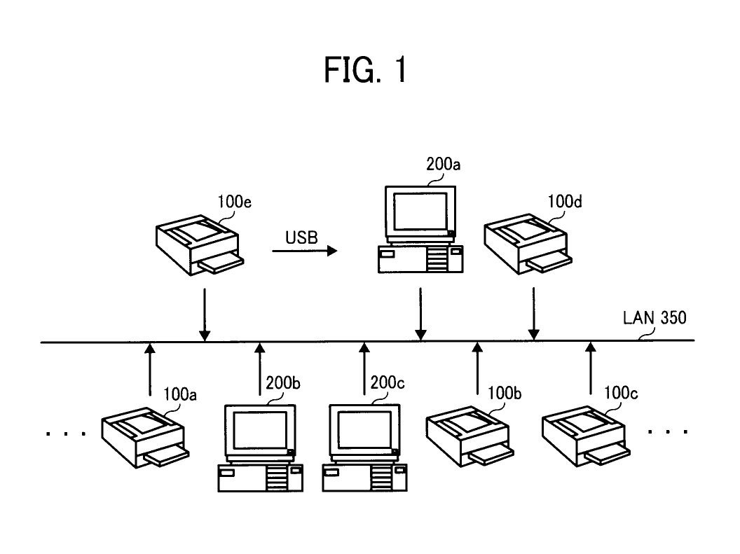

FIG. 1 illustrates a configuration of an image processing system including a plurality of image forming apparatuses, each of which is an example of an electronic apparatus. The image processing system includes a plurality of image forming apparatuses 100 (collectively referred to as the image forming apparatus 100) such as a printer A 100a, a printer B 100b, a printer C 100c, a printer D 100d, and a printer E 100e, and a plurality of information processing apparatuses 200 (collectively referred to as the information processing apparatus 200) such as a personal computer (PC) A 200a, a PC B 200b, and a PC C 200c each functioning as a client terminal with respect to the image forming apparatus 100. The image forming apparatus 100 and the information processing apparatus 200 are connected through a local area network (LAN) 350. Further, in this example, the printer E 100e is connected to the PC A 200a via a USB cable.

The image processing system of FIG. 1 functions as an electric power supply system, using an interface that allows data transmission or reception through a network as well as electric power supply over the network. More specifically, each of the image forming apparatuses 100, which is connected to the LAN 350, is provided with a network interface with the Power over Ethernet (PoE) technology. The PoE technology allows an electronic apparatus to transmit electric power to another electronic apparatus, or receive electric power from another electronic apparatus, through an Ethernet LAN cable. For example, the network interface in compliance with the IEEE802.3af PoE standard may be used. The PoE standard is specified so as to minimize the influences over communication of data, even when electric power is supplied through the cable through which data is exchanged. For example, electric power may be supplied through a switching hub provided with the function of supplying electric power using the PoE technology, or directly through the network interface.

Alternatively, the network interface that allows data transmission or reception and electric power supply may be implemented using the universal serial bus (USB) power technology, which supplies electric power to an electronic apparatus through a USB cable. For example, through the USB cable, electric power may be supplied from a computer (such as the PC A 200a) to its peripheral electronic apparatus (such as the printer E 100e). As long as the electronic apparatus is in compliance with the USB standard, electric power is supplied to the electronic apparatus through the USB cable. This allows the user to place the electronic apparatus at any place without considering a location where the plug is provided. The other examples of such network interface allowing data transmission or reception and electric power supply include the wireless charging system using the IEEE1394 telephone line or the wireless LAN.

[Configuration of Image Forming Apparatus]

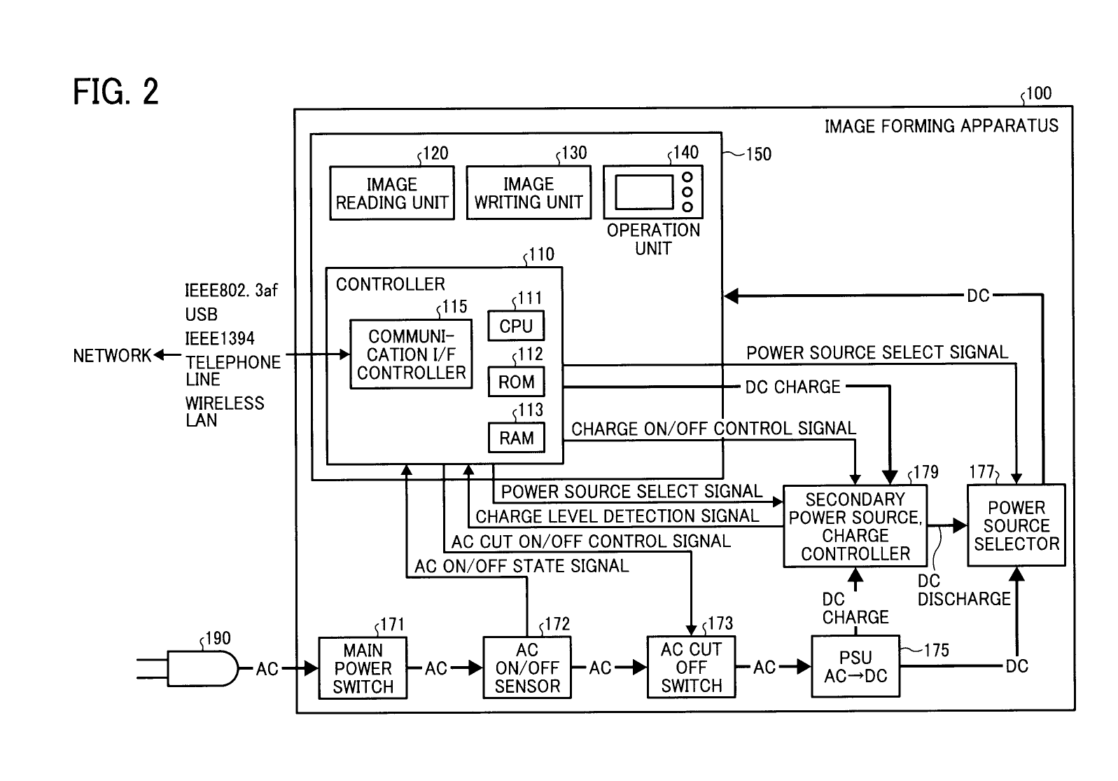

Referring now to FIG. 2, a structure of the image forming apparatus 100 of the image processing system of FIG. 1 is explained according to an example embodiment of the present invention. In this example, the image forming apparatus 100 is implemented by a printer capable of scanning, printing, copying, and transmitting or receiving data through a network. Alternatively, the image forming apparatus 100 may be implemented by a copier, a facsimile, or a multifunctional apparatus (MFP) capable of performing a plurality of image forming functions including printing, copying, and scanning.

The image forming apparatus 100 mainly includes a data processing unit 150 and a power supply section that supplies direct current (DC) electric power to the data processing unit 150.

The data processing unit 150 includes a controller 110 that controls the image forming apparatus 100. The controller 110 controls various devices in the image forming apparatus 100 to perform various functions such as copying, printing, and scanning. Further, the controller 110 controls various devices that perform operation of controlling electric power supply so as to suppress electric power consumption of the image forming apparatus 100 and/or the entire image processing system.

The controller 110 includes a central processing unit (CPU) 111, a read only memory (ROM) 112, and a random access memory (RAM) 113. The ROM 112 stores therein various control programs and control data. When executed, the control programs and control data are loaded onto the RAM 113 functioning as a work memory of the CPU 111 to cause the CPU 111 to perform control operation according to the control programs being loaded.

The controller 110 further includes a communication interface (I/F) controller 115. Under control of the controller 110, the communication I/F controller 115 operates as an interface such as the network interface that connects the image forming apparatus 100 with an external apparatus through the network such as the LAN 350 to allow transmission or reception of data through the network. Further, the communication I/F controller 115 is provided with the function of transmission or receiving electric power to or from an external apparatus through the network, for example, using the PoE technology.

The data processing unit 150 further includes an operation unit 140, an image reading unit 120, and an image writing unit 130. The operation unit 140 functions as a user interface that interacts with a user. The operation unit 140 receives a user instruction that requests the image forming apparatus 100 to perform desired processing, or notifies the user of various information such as the current state of the image forming apparatus 100, for example, through a touch panel screen. The image reading unit 120 scans an original image into scanned image data. The image writing unit 130 forms an image based on image data such as the scanned image data to generate a printed image. In alternative to forming the image based on the scanned image data, the image writing unit 130 may form an image based on image data transmitted from the information processing apparatus 200 through the network such as the LAN 350.

The power supply section of the image forming apparatus 100, which controls electric power supply to the data processing unit 150, includes a power source plug 190, a main power switch 171, an alternating current (AC) ON/OFF sensor 172, an AC cut off switch 173, a power supply unit (PSU) 175, a power source selector 177, and a secondary power source 179.

The power source plug 190 supplies the image forming apparatus 100 with AC electric power from a commercial AC power source, when the plug 190 is connected to the AC power source. The main power switch 171 turns on or off the AC power supply that is supplied through the plug 190, for example, according to a user instruction received through the operation unit 140. The AC ON/OFF sensor 172 detects the on/off state of the main power switch 171 to output a detection signal to the controller 110. The detection signal output by the AC ON/OFF sensor 172 is referred to as an AC ON/OFF state signal.

The AC cut off switch 173 receives an AC cut ON/OFF control signal that indicates whether to cut off electric power supply from the commercial AC power source, from the controller 110. Based on the AC cut ON/OFF control signal, the AC cut off switch 173 opens or closes such as a relay to control supply of electric power from the AC power source to the PSU 175. The PSU 175 converts the AC power supply to DC power supply such that the DC power supply is input to other devices such as the data processing unit 150 through the power source selector 177, and the secondary power source 179.

The secondary power source 179 is provided with a charger such as the secondary battery. For the descriptive purposes, the secondary power source 179 may be referred to as the secondary battery 179. The secondary battery 179 is charged with electric power, which is received from the PSU 175, or from an external apparatus such as another image forming apparatus 100 through the communication I/F controller 115 of the controller 110. The secondary power source 179 further includes a charge controller, which controls operation of the secondary battery 179 according to a power source select signal and a charge ON/Off control signal that are respectively received from the controller 110. The charge controller of the secondary power source 179 detects the amount of charged electric power in the secondary battery 179, and sends a charge level detection signal to the controller 110 to notify of the detected charged level of the secondary battery 179. The amount of charged electric power in the secondary battery 179 may be referred to as the charge level of the secondary battery 179.

The power source selector 177 selects either the PSU 175 or the secondary battery 179 based on the power source select signal received from the controller 110, and supplies the DC electric power from the selected one of the PSU 175 and the secondary battery 179 to the data processing unit 150. In this example, the controller 110 is constantly supplied with DC electric power either from the PSU 175 or the secondary battery 179 through the power source selector 177.

The controller 110 receives various data from another device in the image forming apparatus 100. The controller 110 receives a monitoring result of the AC ON/OFF sensor 172 that monitors the AC electric power supplied through the plug 190 in the form of AC ON/OFF state signal, and determines the current on/off state of the main power switch 171. The controller 110 further receives information regarding the state of the image forming apparatus 100 such as instructions input through the operation unit 140. When the state of the image forming apparatus 100 satisfies a predetermined condition for switching to an energy save mode, the controller 100 switches an operation mode of the image forming apparatus 100 from another operation mode such as a normal operation mode, to the energy save mode. For example, the controller 110 switches the operation mode to the energy save mode when no user instruction is received for a predetermined time period, or a user instruction for switching to the energy save mode is received through the operation unit 140. When the energy save mode is set so as to require a high energy conservation level in which the image forming apparatus 100 consumes “substantially 0 W” from the commercial AC power source, the controller 110 sends the control signal that instructs cutting off of AC power supply to the AC cut off switch 173. Based on the control signal, the AC cut off switch 173 cuts off the AC electric power supply from the power source plug 190.

When the AC electric power supply is cut off, the controller 110 sends a power source select signal indicating selection of the secondary battery 179 to the power source selector 177 and to the secondary battery 179 as a control signal. The secondary battery 179 starts supplying DC electric power to the power source selector 177 to cause the power source selector 177 to switch the power source from the PSU 175 to the secondary battery 179 such that the DC electric power is supplied from the secondary battery 179 to the data processing unit 150 through the power source selector 177.

When the AC electric power supply is on, the controller 110 sends a power source select signal indicating selection of the PSU 175 to the power source selector 177 and to the secondary battery 179. The DC electric power that is converted at the PSU 175 is supplied to the data processing unit 150 through the power source selector 177.

More specifically, with the power source select signal indicating whether the power source is switched to the PSU 175 or to the secondary battery 179, the charge controller of the secondary battery 179 causes the secondary battery 179 to start or stop supplying the DC electric power to the power source selector 177.

Further, the charge controller of the secondary battery 179 may cause the secondary battery 179 to be charged with the DC electric power supplied from either the PSU 175 or the controller 110, according to a charge ON/Off control signal indicating whether to be charged with electric power.

When the PSU 175 is selected as the power source supplying DC electric power, the secondary battery 179 may be charged with DC electric power supplied from the PSU 175. Alternatively, the charge controller of the secondary battery 179 causes the secondary battery 179 to be charged with electric power supplied from the controller 110, when the image forming apparatus 100 receives the DC electric power from the external apparatus through the communication I/F controller 115 of the controller 110. The secondary battery 179 may be charged with electric power supplied from the communication I/F controller 115 at any desired time as long as the secondary battery 179 is not charged with electric power supplied from the PSU 175.

Further, the image forming apparatus 100 may transmit electric power to another apparatus on the network through the communication I/F controller 115. For example, the controller 110, which is supplied with DC electric power from the power source selector 177, causes the electric power to be transmitted to an external apparatus through the communication I/F controller 115 to charge a secondary battery in the external apparatus.

In the normal operation mode in which the power source selector 177 selects the PSU 175 as the power source, DC electric power from the PSU 175 is supplied to the external apparatus. In the energy save mode in which the power source selector 177 selects the secondary battery 179 as the power source, DC electric power from the secondary battery 179 is supplied to the external apparatus. In an operation mode in which electric power can be supplied from any one of the PSU 175 and the secondary battery 179, electric power from the PSU 175 is supplied to the external apparatus in high priority.

[Electric Power Conservation Performed by Image Processing System]

Now, operation of conserving electric power consumption, performed by the image processing system of FIG. 1, is explained. As described below, electric power conservation is achieved by allowing electric power to be exchanged among a plurality of electronic apparatuses in the system via an interface provided in each electronic apparatus.

For example, when the image forming apparatus 100 is switched to the energy save mode, the image forming apparatus 100 turns off the main power switch 171 or the AC cut off switch 173 to cut off electric power supplied from the commercial AC power source. The power source of the image forming apparatus 100 is thus switched to the secondary battery 179, causing the commercial electric power consumption to be substantially 0 W.

The secondary battery 179 in each of the image forming apparatus 100, however, has a limited capacity such that all electric power charged in the secondary battery would be eventually used up as the image forming apparatus 100 operates. To start charging the secondary battery 179, the image forming apparatus 100 can be switched back to the normal operation mode by turning on the main power switch 171 or the AC cut off switch 173. However, as the operation mode is switched to the normal operation mode, a large amount of electric power supply would be consumed depending on the conversion efficiency of AC/DC conversion of the PSU 175. In order to improve the efficiency in electric power conservation, it would be preferable to keep supplying electric power from the secondary battery 179 for a longer time period.

To charge the secondary battery 179 without causing the image forming apparatus 100 to switch back to the normal operation mode, the image forming apparatus 100 is provided with the function of supplying electric power through an interface such as using the PoE technology. As described above referring to FIG. 1, a switching hub may be provided on the LAN 350 to supply electric power that is generated at the switching hub to the secondary battery 179 of the image forming apparatus 100. This, however, lowers efficiency in electric power conservation in the entire system as the switching hub itself consumes AC electric power.

In view of this, in the following examples, the image forming apparatus 100 in the image processing system of FIG. 1 is provided with the secondary battery 179 and the communication I/F controller 115. The image forming apparatus 100 is further provided with the controller 110, which determines whether to transmit or receive electric power through the communication I/F controller 115 to generate a determination result. The determination result is generated based on whether a certain condition is met so as to keep a sufficiently high level of efficiency in electric power conservation in the image processing system. Based on the determination result, the controller 110 causes the image forming apparatus 100 to transmit or receive electric power to or from another apparatus through the communication I/F controller 115.

### <Control of Electric Power Supplied to an External Electronic Apparatus>

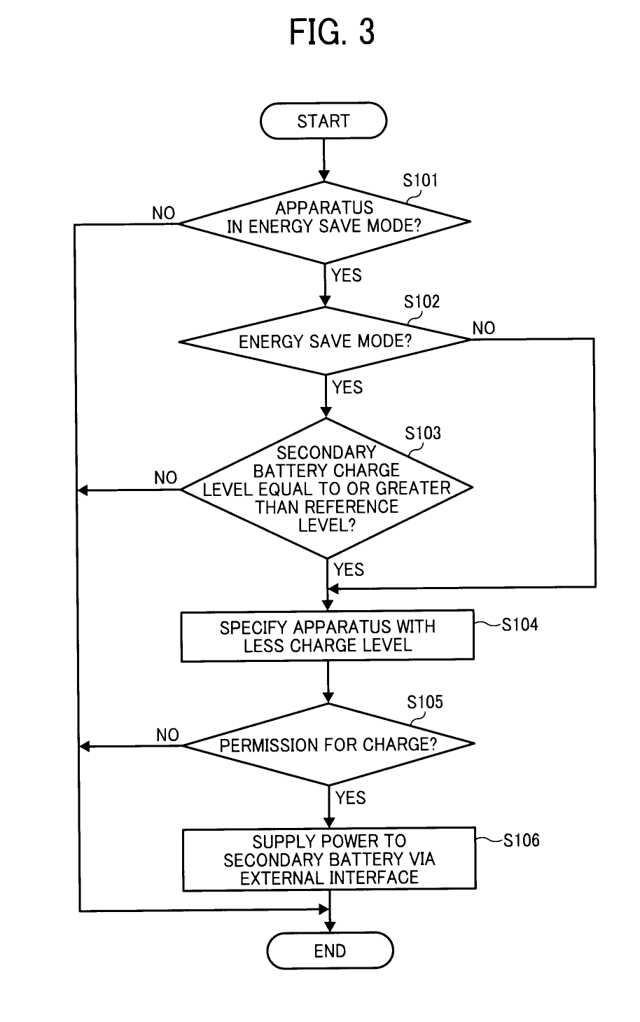

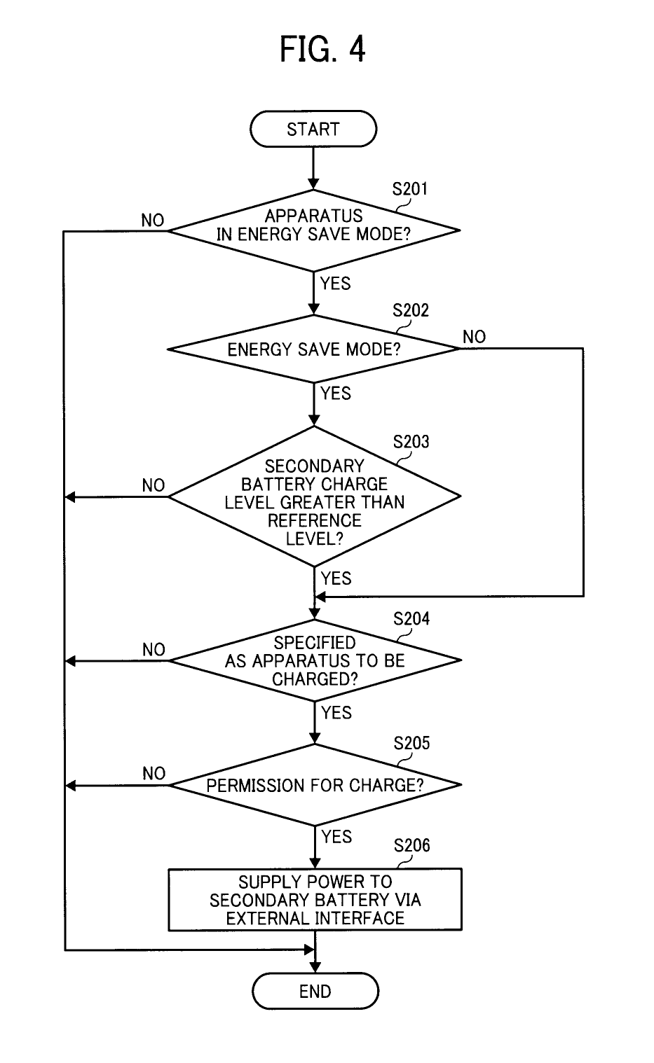

Referring now to FIGS. 3 and 4, operations of controlling transmission of electric power supply to another image forming apparatus 100 through the communication I/F controller 115, performed by the image forming apparatus 100, is explained according to example embodiments of the present invention. The operation of controlling transmission of electric power supply may be performed by any one of the printers 100a to 100e at any desired time. In this example, it is assumed that each one of the printers 100a to 100e is programmed to perform operation of FIG. 3 or 4 periodically. More specifically, the image forming apparatus 100 is provided with a control program for controlling transmission of electric power supply to an external electronic apparatus, which may be stored in a memory such as the ROM 112. Upon execution of the control program, the controller 110 of the image forming apparatus 100 performs operation of FIG. 3 or 4. Through performing FIG. 3 or 4, the image forming apparatus 100 determines whether to start supplying electric power to an external image forming apparatus to charge the secondary battery in the external apparatus, specifies one external image forming apparatus that is most suitable, and starts supplying electric power to the specified image forming apparatus. With this control operation, the secondary batteries in the image processing system are efficiently used so as to improve efficiency in electric power conservation in the entire system.

### <Data Structure of Management Information and Method of Sharing Such Data>

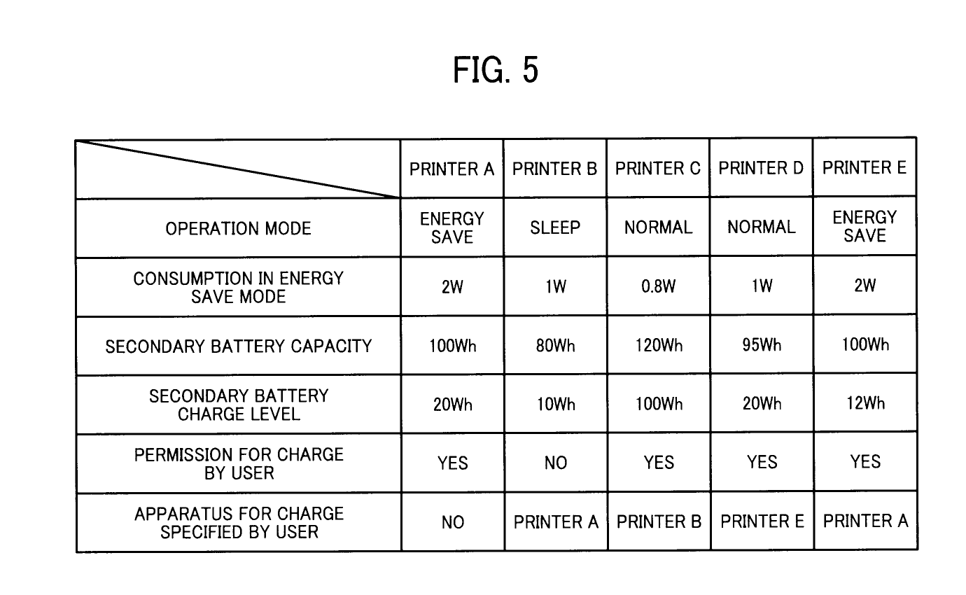

FIG. 5 illustrates an example data structure of management information regarding the image forming apparatuses 100, managed by the image processing system of FIG. 1.

The management information of FIG. 5 includes information regarding the charged state of the secondary battery 179 for each one of the printers 100a to 100e each functioning as the image forming apparatus 100. Based on the management information, the image forming apparatus 100 selects an external image forming apparatus 100 that is most suitable as an apparatus having the secondary battery to be charged with electric power supplied from the image forming apparatus 100. The management information may be stored in any desired form in a manner such that the image forming apparatus 100 in the image processing system accesses the management information at any desired time. For example, as described below, the management information may be updated and shared among the image forming apparatuses 100 in the system through the network. Based on the management information that is received, the image forming apparatus 100 manages the management information of FIG. 5, which may be stored in a memory of the apparatus 100.

More specifically, the management information of FIG. 5 includes “operation mode”, “power consumption in energy save mode”, “secondary battery capacity”, “secondary battery charge level”, “permission for charge by user”, and “apparatus for charge specified by user”.

The operation mode indicates a current operation mode of the image forming apparatus 100 such as whether the current operation mode is the energy save mode (“ENERGY SAVE”), sleep mode (“SLEEP”), or normal operation mode (“NORMAL”). Alternatively or additionally, any desired operation mode may be specified. For example, in alternative to the sleep mode, a stand-by mode or a warm-up mode may be used. The power consumption in energy save mode indicates electric power being consumed per a unit time when the image forming apparatus 100 is in the energy save mode. The secondary battery capacity indicates the capacity of the second battery 179, which is determined by the charge level of the secondary battery 179 when the secondary battery 179 is fully charged. The secondary battery charge level indicates a current charged amount or level of the secondary battery 179. The permission for charge by user indicates whether the user permits the secondary battery 179 of the image forming apparatus 100 to be charged with electric power supplied from another image forming apparatus 100 through the external interface such as the communication I/F controller 115. The apparatus for charge specified by user specifies an image forming apparatus 100 that is specified by the user as a destination to which electric power is to be supplied from the image forming apparatus 100, when the specified apparatus needs to be charged.

In this example, the management information of FIG. 5 is constantly updated and shared among the plurality of image forming apparatuses 100 in the image processing system of FIG. 1. More specifically, the image forming apparatus 100 sends management information regarding its own apparatus in the form of management information base (MIB) information, according to Simple Network Management Protocol (SNMP), to the network such as the LAN 350.

The SNMP is a protocol to be used for monitoring or controlling an apparatus such as a router, computer, or terminal that is connected to the network in compliance with the Transmission Control Protocol (TCP)/Internet Protocol (IP), through the network. The apparatus subjected for SNMP control is provided with the MIB information. Using the MIB information of each apparatus, each apparatus in the image processing system is managed. Through sending the MIB information of its own apparatus, each apparatus is able to notify another apparatus of the current operation state of each apparatus. Further, examples of MIB include the MIB1 specified by the Request for Comment (RFC) 1156, and the MIB2 specified by the RFC 1213.

Referring now to FIG. 3, operation of controlling transmission of electric power supply to another image forming apparatus 100 in the image processing system of FIG. 1, performed by the image forming apparatus 100, is explained according to an example embodiment of the present invention. The operation of FIG. 3 is performed by the controller 110 of the image forming apparatus 100 according to the power supply control program.

At S101, the controller 110 refers to the operation mode of the management information of FIG. 5 to determine whether there is any other image forming apparatus that is in the energy save mode. For example, assuming that the printer A 100a is currently performing the operation of FIG. 3, the printer A 100a determines that the printer E 100e is in the energy save mode. In another example, assuming that the printer B 100b is currently performing the operation of FIG. 3, the printer B 100b determines that the printer A 100a and the printer E 100e are each in the energy save mode.

When it is determined that there is no other image forming apparatus 100 that is in the energy save mode (“NO” at S101), the operation ends. In such case, all other image forming apparatuses 100 are supplied with electric power from the AC power source, i.e., the main power source such that the secondary battery 179 is charged with electric power supplied from the PSU 175. There is no need for the image forming apparatus 100 to supply electric power to the secondary battery 179 of another image forming apparatus 100.

When it is determined that there is at least one other image forming apparatus 100 that is in the energy save mode (“YES” at S101), the operation proceeds to S102. At S102, the controller 110 determines whether the operation mode of the image forming apparatus 100 itself is in the energy save mode. When it is determined that its operation mode is not the energy save mode (“NO” at S102), the operation proceeds to S104. In such case, the image forming apparatus 100 operates with DC electric power supplied from the AC power source through the PSU 175.

When it is determined that its operation mode is the energy save mode (“YES” at S102), the operation proceeds to S103 to check the charge level of its secondary battery 179, for example, by referring to the management information. Alternatively, the charge level of the secondary battery 179 may be obtained in the form of the charge level detection signal sent from the secondary battery 179.

When it is determined that the charge amount, or charge level, of the secondary battery 179 of the image forming apparatus 100 is equal to or greater than a reference level, it is determined that the charge amount or level is sufficiently large and the operation proceeds to S104. When it is determined that the charge amount or level of the secondary battery 179 of the image forming apparatus 100 is less than the reference level, it is determined that the charge amount or level is not sufficiently large and the operation ends. For example, when the charge level of the secondary battery 179 is equal to or greater than 50% of the battery capacity, it is determined that the charge level is sufficiently large. Otherwise, the operation ends as there is no remaining electric power to be supplied to another apparatus.

For example, assuming that the printer A 100a is currently performing operation of FIG. 3, at S102, the printer A 100a determines that the operation mode is the energy save mode by referring to the management information of FIG. 5. At S103, the printer A 100a determines that the secondary battery charge amount or level of 20 Wh is less than half of the secondary battery capacity of 100 Wh (“NO” at S103), and the operation ends.

Assuming that the printer B 100b is currently performing operation of FIG. 3, at S102, the printer B 100b determines that the operation mode is not the energy save mode, i.e., the sleep mode, by referring to the management information of FIG. 5, and the operation proceeds to S104.

At S104, the controller 110 of the image forming apparatus 100 specifies one of the image forming apparatuses 100 having the secondary battery with a lowest charge level such that the remaining life of the secondary battery is shortest, if more than one another image forming apparatus 100 that is in the energy save mode is detected at S101. For example, assuming that the printer B 100b is currently performing operation of FIG. 3, the printer E 100e is specified at S104, as the secondary battery charge level (12 Wh) of the printer E 100e is lower than that (20 Wh) of the printer A 100a.

At S105, the controller 110 of the image forming apparatus 100 determines whether the user permits the image forming apparatus 100 that is specified at S104 to be charged by the image forming apparatus 100. This is determined by referring to the management information “permission for charge by user” in FIG. 5. When it is determined that there is permission for charge, that is, the “permission for charge by user” is set to “YES” (“YES” at S105), the operation proceeds to S106. When it is determined that there is no permission for charge, that is, the “permission for charge by user” is set to “NO” (“NO” at S105), the operation ends.

At S106, the controller 110 of the image forming apparatus 100 starts supplying electric power through the interface such as the communication I/F controller 115 to the external image forming apparatus 100 that is specified at S104 so as to charge the secondary battery 179 in the external image forming apparatus 100. At the external image forming apparatus 100, electric power received through the communication I/F controller 115 from the image forming apparatus 100 is supplied to the secondary battery 179 through the controller 110. For example, assuming that the printer E 100e is specified by the printer B 100b, the printer B 100b supplies electric power to the printer E 100e as it is permitted by the user.

As described above, one of the image forming apparatuses 100 in the image processing system that is capable of supplying electric power specifies an external image forming apparatus 100, which is in the energy save mode and having the shortest battery life of the secondary battery 179. The image forming apparatus 100 starts supplying electric power to the external image forming apparatus 100 that is specified. As the electric power is supplied from another image forming apparatus 100, the image forming apparatus 100 in the energy save mode is supplied with electric power from the secondary battery 179 for a longer time period, thus preventing the image forming apparatus 100 in the energy save mode from using up its secondary battery 179 and switching back to the normal operation mode. As the operation mode is kept in the energy save mode for a longer time period, electric power consumption in the entire image processing system is suppressed. The efficiency in electric power conservation in the system improves especially when electric power consumption in the energy save mode does not vary so much among electronic apparatuses in the system.

Referring now to FIG. 4, operation of controlling transmission of electric power supply to another image forming apparatus 100 in the image processing system of FIG. 1, performed by the image forming apparatus 100, is explained according to an example embodiment of the present invention. The operation of FIG. 4 is substantially similar to the operation of FIG. 3, except for the difference that includes replacement of S104 with S204.

S201 to S203 are performed in a substantially similar manner as described above referring to S101 to S103 of FIG. 3.

At S204, the controller 110 of the image forming apparatus 100 determines whether the image forming apparatus 100 that is determined to be in the energy save mode at S201 is specified as an apparatus to be charged with the image forming apparatus 100, for example, by referring to the management information “apparatus for charge specified by user” in FIG. 5. When it is determined that the image forming apparatus 100 is specified as an apparatus to be charged, that is, the “apparatus for charge specified by user” is “YES” (“YES” at S204), the operation proceeds to S205. When it is determined that the image forming apparatus 100 is not specified as an apparatus to be charged, that is, the “apparatus for charge specified by the user” is “NO” (“NO” at S204), the operation ends.

For example, assuming that the printer B 100b is currently performing operation of FIG. 4, the printer A 100a is specified as the apparatus subjected for charge by the printer B 100b. At S204, of the printer A 100a and the printer E 100e that are specified at S201, the printer B 100b selects the printer A 100a as the image forming apparatus 100 subjected for charge by the printer B 100b, even though the printer A 100a has the battery charge level higher than that of the printer E 100e.

S205 and S206 are performed in a substantially similar manner as described above referring to S105 and S106 of FIG. 3.

More specifically, referring to FIG. 3, the image forming apparatus 100 having the secondary battery 170 with the shorter remaining life is supplied with electric power in high priority. Referring to FIG. 4, the image forming apparatus 100 that is previously set by the user is supplied with electric power in high priority.

In alternative to performing operation of FIG. 3 or 4, any desired image forming apparatus 100 may perform operation of FIG. 3 with the additional step of S204.

Now, operation of controlling electric power supply in the image processing system of FIG. 1 is explained, using the management information of FIG. 5.

Referring to the management information of FIG. 5, the printer A 100a is in the energy save mode, and its battery life of the secondary battery 179 is low such that the printer A 100a does not supply electric power to another apparatus. Rather, the printer A 100a, which is set by the user to permit charging with electric power supplied from another apparatus, is waiting to receive electric power from another apparatus.

The printer D 100d is in the normal operation mode such that it can transmit electric power supply to another apparatus. As the apparatus specified by the user for the printer D 100d is set to the printer E 100e, the printer D 100d is controlled to transmit electric power supply to the printer E 100e in high priority.

The printer E 100e is in the energy save mode, and its battery life of the secondary battery 179 is low such that the printer E 100e is waiting for electric power to be supplied from another apparatus. As the permission for charge by user is set to “YES”, the printer E 100e is waiting to receive electric power from another apparatus. In this example, since the printer E 100e is set as an apparatus to be charged by the printer D 100d, the printer E 100e receives electric power from the printer D 100d.

The printer C 100c is in the normal operation mode such that it can transmit electric power supply to another apparatus. As the apparatus specified by the user is set to the printer B 100b, the printer C 100c is controlled to transmit electric power supply to the printer B 100b in high priority.

The printer B 100b is in the sleeping mode, and its battery life of the secondary battery 179 is low such that the printer B 100b is waiting for electric power to be supplied from another apparatus. As the permission for charge by use is set to “NO” for the printer B 100b, the printer B 100b is not supplied with electric power from the printer C 100c, even though the printer C 100c is set to supply electric power to the printer B. Instead, the printer B 100b charges the secondary battery 179 by itself.

As described above, in an electric supply system, an electronic apparatus having an operation state in which electric power is supplied from a supplementary power source, such as an electronic apparatus in the energy save mode, is specified. When more than one such electronic apparatus is specified, the electronic apparatus with the lowest level of electric charge is selected. Electric power is supplied to the selected electronic apparatus through an interface having the function of electric power transmission/reception, from an electronic apparatus with a supplementary power source having a sufficient level of electric charge. The selected electronic apparatus charges the supplementary power source with electric power supplied from the external electronic apparatus. This causes the electronic apparatus in the energy save mode to be supplied from the supplementary power source for a longer time period, thus improving the efficiency in electric power conservation in the entire system.

<Control of Electric Power Supplied from an External Electronic Apparatus>

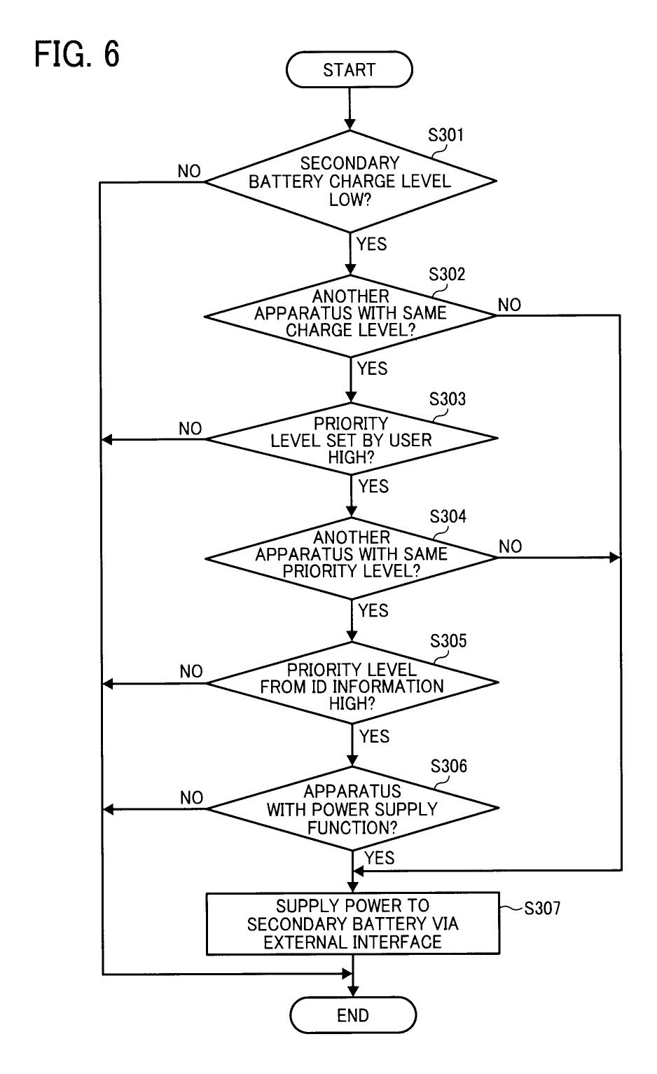

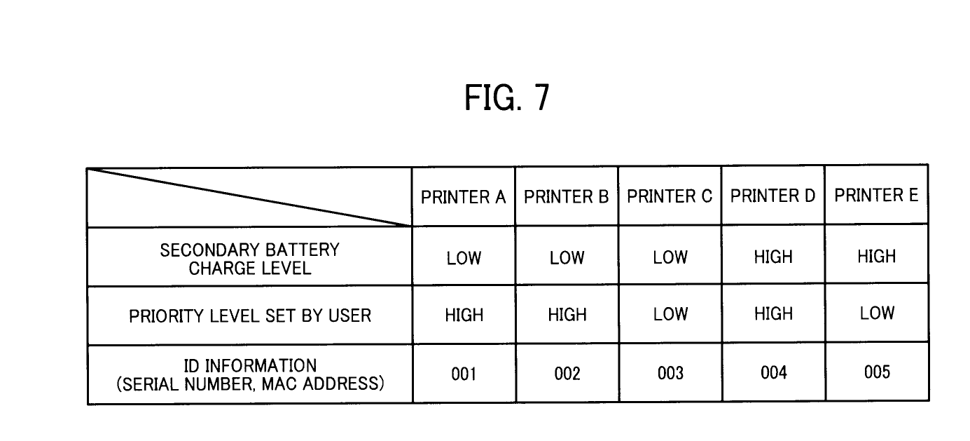

Referring now to FIGS. 6 and 7, operation of controlling reception of electric power supply from another image forming apparatus 100 through the communication I/F controller 115, performed by the image forming apparatus 100, is explained according to an example embodiment of the present invention. The operation of controlling reception of electric power supply may be performed by any one of the printers 100a to 100e at any desired time. In this example, it is assumed that each one of the printers 100a to 100e is programmed to perform operation of FIG. 6 periodically. More specifically, the image forming apparatus 100 is provided with a control program for controlling reception of electric power supply from an external electronic apparatus, which may be stored in a memory such as the ROM 112. Upon execution of the control program, the controller 110 of the image forming apparatus 100 performs operation of FIG. 6. Through performing operation of FIG. 6, the image forming apparatus 100 determines whether to start receiving electric power from an external image forming apparatus to charge its secondary battery 179, specifies one image forming apparatus that is most suitable for supplying electric power, and starts receiving electric power from the specified image forming apparatus. With this control operation, the secondary batteries in the image processing system are efficiently used so as to improve efficiency in electric power conservation in the entire system.

<Data Structure of Management Information>

FIG. 7 illustrates an example data structure of management information regarding the image forming apparatuses 100, managed by the image processing system of FIG. 1.

The management information of FIG. 7 includes information regarding the charged state of the secondary battery 179 and identification information for each one of the printers 100a to 100e each functioning as the image forming apparatus 100. Based on the management information, the image forming apparatus 100 selects an image forming apparatus that is most suitable as an apparatus from which electric power is supplied.

More specifically, the management information of FIG. 7 includes “secondary battery charge level”, “priority level set by user”, and “identification (ID) information”.

The secondary battery charge level indicates whether a current charge level of the secondary battery 179 of the image forming apparatus 100 is equal to or greater than a reference charge level. When it is determined that the current charge level is equal to or greater than the reference charge level, the secondary battery charge level is set to “HIGH”. When it is determined that the current charge level is lower than the reference charge level, the secondary battery charge level is set to “LOW”. For example, the reference charge level may be set to 50% of the battery capacity indicating the amount of electric power when the battery is fully charged. With this secondary battery charge level information, electric power is supplied from the apparatus having the higher charge level to the apparatus having the lower charge level.

The priority level set by the user indicates the degree of priority in charging as specified by the user. In this example, the priority level is set by the user who is most likely to know the usage status of the image forming apparatus 100. With this priority level information, electric power is supplied from the apparatus having the lower priority level to the apparatus having the higher priority level.

The identification information is used for identifying the image forming apparatus 100 such as a serial number or a media access control (MAC) address that is uniquely assigned to the image forming apparatus 100. Using this identification information, the priority in charging may be determined among the image forming apparatuses 100, when it is determined that more than one image forming apparatus 100 in the system needs to be charged with electric power supplied from another apparatus.

The management information of FIG. 7 is constantly updated and shared among the plurality of image forming apparatuses 100 in the image processing system of FIG. 1. More specifically, as described above referring to FIG. 5, the image forming apparatus 100 sends management information regarding its own apparatus in the form of MIB information, according to SNMP, to the network such as the LAN 350. Based on the management information that is received, the image forming apparatus 100 manages the management information of FIG. 7, which may be stored in a memory of the apparatus 100.

Referring now to FIG. 6, operation of controlling reception of electric power supply from another image forming apparatus 100 in the image processing system of FIG. 1, performed by the image forming apparatus 100, is explained according to an example embodiment of the present invention. The operation of FIG. 6 is performed by the controller 110 of the image forming apparatus 100. The operation of controlling reception of electric power supply may be performed by any one of the printers 100a to 100e at any desired time. In this example, it is assumed that each one of the printers 100a to 100e is programmed to perform operation of FIG. 6 periodically.

At S301, the controller 110 of the image forming apparatus 100 refers to the secondary battery charge level of the management information of FIG. 7 to determine whether the charge level of its secondary battery 179 is low. When it is determined that the charge level of its secondary battery 179 of the image forming apparatus 100 is high (“NO” at S301), the operation ends as there is no need to be charged with electric power supplied from another apparatus. When it is determined that the charge level of its secondary battery 179 is low (“YES” at S301), it is determined that there is need for charging the secondary battery 179 with electric power supplied from another image forming apparatus 100.

More specifically, when the secondary battery charge level of the image forming apparatus 100 is set to “LOW”, the operation proceeds to S302. When the secondary battery charge level of the image forming apparatus 100 is set to “HIGH”, the operation ends.

At S302, the controller 110 refers to the secondary battery charge level of the management information of FIG. 7 to determine whether there is any other external image forming apparatus 100 that is needed to be charged. When it is determined that there is no image forming apparatus with the low battery charge level (“NO” at S302), the operation proceeds to S307. When it is determined that there is at least one other image forming apparatus with the low battery charge level (“YES” at S302), the operation proceeds to S303.

Assuming that the printer A 100a is currently performing operation of FIG. 6, at S301, it is determined that the printer A 100a needs to be charged as the printer A 100a has the low charge level referring to FIG. 7. At S302, the printer A 100a determines that there are the printer B 100b and the printer C 100c each having the low level of the secondary battery (“YES” at s302), and the operation proceeds to S303.

At S303, the controller 110 of the image forming apparatus 100 refers to the management information “priority level set by user” of FIG. 7 to determine whether the priority level set by the user is set to high for the image forming apparatus 100. When it is determined that the priority level set by the user for the image forming apparatus 100 is set to low (“NO” at S303), the operation ends. When it is determined that the priority level set by the user for the image forming apparatus 100 is set to high (“YES” at S303), the operation proceeds to S304. For example, referring to FIG. 7, assuming that the printer A 100a performs operation of FIG. 6, the printer A 100a has the high priority level set by the user, and the operation proceeds to S304.

At S304, the controller 110 of the image forming apparatus 100 refers to the management information “priority level set by user” of FIG. 7 to determine whether there is any other image forming apparatus having the high priority level. When it is determined that there is no other image forming apparatus 100 having the high priority level (“NO” at S304), the operation proceeds to S307. When it is determined that there is at least one other image forming apparatus 100 having the high priority level (“YES” at S304), the operation proceeds to S305. For example, assuming that the printer A 100a is currently performing operation of FIG. 6, since the printer B 100b has the high priority level, the operation proceeds to S305.

At S305, the controller 110 of the image forming apparatus 100 refers to the identification information of FIG. 7 to obtain a priority level that is previously determined for each apparatus. More specifically, in this example, the identification information of the image forming apparatus 100 is associated with a priority level that is previously determined for each of the image forming apparatuses 100, according to a specific rule such that efficiency in electric power conservation improves in the entire system.

In one example, assuming that the image forming apparatus 100 that needs to be charged is in the energy save mode in which electric power is supplied from the secondary battery, if the image forming apparatus 100 in the energy save mode is able to be supplied with electric power from the secondary battery for a longer time period, electric power consumption is conserved in the entire system. In such case, the image forming apparatus having the secondary battery that has a longer operation time period, that is, the secondary battery having a shorter battery life or charge level, should be charged in high priority. Especially when electric power consumption rate in the energy save mode does not differ among electronic apparatuses in the system, supplying electric power to the electronic apparatus having the supplementary power source with a shorter battery life improves efficiency in electric power conservation. For this reasons, the priority level of the image forming apparatus 100 may be set based on information regarding the secondary battery.

In another example, assuming that the image forming apparatus 100 that needs to be charged is in the normal operation mode in which electric power is supplied from the main power source, if the image forming apparatus 100 in the energy save mode is able to be supplied with electric power from the secondary battery for a longer time period, electric power consumption is conserved in the entire system. In such case, the image forming apparatus 100 with a low conversion efficiency is selected as the apparatus to be supplied with electric power in high priority. The conversion efficiency of the image forming apparatus 100 is its capability in converting electric power supplied from the main power source to electric power for charging the supplementary power source. For example, the conversion efficiency corresponds to the conversion efficiency of AC/DC conversion of the PSU 175. For this reasons, the priority level of the image forming apparatus 100 may be set based on information regarding the conversion efficiency.

When the priority level associated with the identification information is obtained, at S305, the controller 110 of the image forming apparatus 100 determines whether the priority level that is specified using the identification information is high. When it is determined that the priority level specified using the identification information is low (“NO” at 305), it is determined that there is no need to receive electric power for charging the secondary battery for the image forming apparatus 100, and the operation ends. When it is determined that the priority level specified using the identification information is high (“YES” at S305), the operation proceeds to 306.

For example, in case the printer A 100a is currently performing operation of FIG. 6, the controller 110 of the printer A 100a refers to the identification information of the printer A 100a and the printer B 100b of FIG. 7. In this example, the serial number “001” is stored as the identification information of the printer A 100a, and the serial number “002” is stored as the identification information of the printer B 100b. Further, the serial number “001” of the printer A 100a is associated with a priority level specifically set for the printer A 100a, and the serial number “002” of the printer B100b is associated with a priority level specifically set for the printer B 100b. Further, in this example, the priority level that is associated with the serial number “001” of the printer A 100a is set higher than the priority level that is associated with the serial number “002” of the printer B 100b. Based on the priority level that is associated with the identification information, the controller 110 of the image forming apparatus 100 determines that the printer A 100a is to be charged with electric power in high priority.

In alternative to assigning a priority level for each of the image forming apparatuses 100 in association with the identification information of the image forming apparatus 100, the controller 110 may define a priority level for each of the image forming apparatuses 100 using the identification information such that the image forming apparatus 100 having a smaller serial number has a higher priority. In such case, the image forming apparatuses 100 having the same values for secondary battery charge level and priority level are charged in an order defined by its serial number.

Still referring to FIG. 6, at S306, the controller 110 of the image forming apparatus 100 determines whether there is any other image forming apparatus capable of transmitting electric power to the image forming apparatus 100, through an external interface, for example, using the PoE technology. When it is determined that there is at least one image forming apparatus 100 provided with the function of supplying electric power (“YES” at S306), the operation proceeds to S307. When it is determined that there is no image forming apparatus 100 provided with the function of supplying electric power (“NO” at S306), the operation ends.

At S307, the controller 110 of the image forming apparatus 100 starts receiving electric power supplied from another image forming apparatus 100 via the communication I/F controller 115. With electric power supplied via the communication I/F controller 115, the secondary battery 179 is charged.

More specifically, at S307, the controller 110 of the image forming apparatus 100 may send a request for transmitting electric power to the image forming apparatus, to the external image forming apparatus 100 when the apparatus 100 provided with the function of supplying electric power is detected.

At S306, when there is more than one other image forming apparatus 100 capable of transmitting electric power to the image forming apparatus 100, the image forming apparatus 100 that is most suitable for transmitting electric power to the image forming apparatus 100 is selected, for example, according to one or more of the following rules.

More specifically, as described above referring to FIGS. 3 and 4, the efficiency in electric power conservation in the entire system improves if the image forming apparatus in the energy save mode is able to operate with electric power supplied from the supplementary power source for a longer time period. This may be achieved by selecting the image forming apparatus that is suitable for charging, such that the life of the secondary batteries in the entire system increases or suppressed from being reduced.

In one example, the image forming apparatus that is suitable for charging may be selected based on whether the image forming apparatus is in the energy save mode. More specifically, the image forming apparatus that operates with electric power supplied from the main power source, such as the image forming apparatus that operates in the normal operation mode, is selected as the image forming apparatus that transmits electric power. This is because the image forming apparatus is able to charge the secondary battery when it is in the normal operation mode, but not able to charge the secondary battery when it is in the energy save mode.

In another example, the image forming apparatus that is suitable for charging may be selected based on whether the battery charge level of the image forming apparatus is sufficiently large.

In another example, the image forming apparatus that is suitable for charging may be selected based on whether the conversion efficiency of the PSU 175 of the image forming apparatus is high. For example, when a plurality of image forming apparatuses are detected each having the normal operation mode, the image forming apparatus 100 having a high conversion efficiency of AC/DC conversion is selected.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

In the above-described examples, it is assumed that each of the image forming apparatuses 100 in the system is provided with the controller 110 that controls electric power supply according to the control program. Alternatively, only one of the image forming apparatuses 100 may be provided with the controller 110 that controls electric power supply according to the control program. Alternatively, any desired number of the image forming apparatuses 100 may be provided with the controller 110 that controls electric power supply according to the control program.

In another example, any desired number of information processing apparatuses 200 may be provided with the controller 110 that controls electric power supply according to the control program. In such case, the information processing apparatus 200 may function as a server that controls electric power supply among the plurality of electronic apparatuses in the system.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

In one example, the present invention may reside in an electronic apparatus, which includes: a main power supply unit, which generates DC electric power from electric power supplied from a main power source when the electric power is supplied from the main power source; a supplementary power source provided with charging means that is controlled to be in a charging state or discharging state, the supplementary power source supplying electric power from the charging means in replace of the main power supply unit when the electric power from the main power source is cut off; an external interface having a communication function and an electric power transmission or reception function with respect to an external electronic apparatus; and controlling means for controlling the external interface to transmit electric power to the external electronic apparatus for charging a supplementary power source in the external apparatus, or to receive electric power from the external electronic apparatus for charging the supplementary power source.

Through controlling transmission or reception of electric power from an electronic apparatus provided with a supplementary power source and an external interface, to or from another external electronic apparatus provided with a supplementary power source and an external interface, electric power conservation is improved in the entire system.

For example, supply of electric power between the electronic apparatuses is controlled such that electric power flows from an electronic apparatus that has a higher charge level of supplementary power source to en electronic apparatus that has a lower charge level of supplementary power source.

In another example, the supplementary power source is charged with electric power supplied from the main power source. The electronic apparatus is provided with means for detecting an external electronic apparatus that operates in an operation mode in which electric power from the main power source is cut off. The controlling means transmits electric power to the external electronic apparatus detected by the detecting means.

In another example, the electronic device is provided with means for detecting a charge level of the supplementary power source of the external electronic device. The controlling means transmits electric power to the external electronic device having a charge level detected by the detecting means that is less than a predetermined value.

The electronic apparatus is provided with means for detecting whether the external electronic apparatus is permitted to be charged with electric power through the external interface. The controlling means transmits electric power to the external electronic apparatus that is permitted to be charged.

The electronic apparatus is provided with means for registering an external electronic apparatus to which the electronic apparatus transmits electric power. The electric controlling means transmits electric power to the external electronic apparatus having the electronic apparatus as the registered apparatus.

The electronic apparatus is provided with means for obtaining AC/DC conversion efficiency of a main power supply unit of the external electronic apparatus. The controlling means transmits electric power to the external electronic apparatus having the AC/DC conversion efficiency that is lower than AC/DC conversion efficiency of the main power supply unit of the electronic apparatus.

The electronic apparatus is provided with means for detecting a charge level of the supplementary power source of the external electronic apparatus. When the charge level of the supplementary power source of the electronic apparatus is less than a predetermined value, the controlling means receives electric power from the external electric apparatus having a charge level of the supplementary power source detected by the detecting means that is equal to or greater than a predetermined value.

The electronic apparatus is provided with means for detecting whether the external electronic apparatus operates with electric power supplied from the main power source. When a plurality of electronic apparatuses that are capable of transmitting electric power is detected, the controlling means receives electric power from the external electronic apparatus that operates with electric power supplied from the main power source in high priority.

The electronic apparatus is provided with means for detecting a time period in which the external electronic apparatus operates with electric power supplied from the supplementary power source. When a plurality of electric apparatuses that are capable of transmitting electric power is detected, the controlling means receives electric power from the external electronic apparatus having a shorter detected time period in high priority.

The electronic apparatus is provided with means for obtaining AC/DC conversion efficiency of the main power supply unit. When a plurality of electric apparatuses that are capable of transmitting electric power is detected, the electric power controlling means receives electric power from the external electronic apparatus having a higher value of AC/DC conversion efficiency of the main power supply unit in high priority.

The on or off of the main power source is performed according to switching of an operation mode to or from an energy save mode.

In one example, a system is provided, which includes one or more of the above-described electronic apparatuses.

In one example, the present invention may reside in a method of controlling electric power supply among a plurality of electronic apparatuses, performed by at least one of the plurality of electronic apparatuses. At least one of the plurality of electronic apparatuses includes a power supply unit, a supplementary power source, and an interface. The method, performed by a controller of at least one of the electronic apparatuses includes: determining whether the supplementary power source of the electronic apparatus has a remaining operation time period that is equal to or greater than a predetermined value to generate a first determination result; causing the interface to transmit electric power from the electronic apparatus to a first selected external electronic apparatus through the network so as to charge an external supplementary power source provided in the first selected external electronic apparatus, when the first determination result indicates that the supplementary power source of the electronic apparatus has the remaining operation time period that is equal to or greater than the predetermined value; and causing the interface to receive electronic power from a second selected electronic apparatus through the network so as to charge the supplementary power source provided in the electronic apparatus, when the first determination result indicates that the supplementary power source of the electronic apparatus has the remaining operation time period that is less than the predetermined value.

Through performing the electric power supply method, the supplementary power sources provided in the electronic apparatuses are suppressed from using up the electric charges, thus improving the efficiency in electric power conservation in the entire system.

In another example, the present invention may reside in a recording medium storing a plurality of instructions which, when executed by a processor, cause an electronic apparatus to perform any one of the above-described methods of controlling electric power supply.

What is claimed is:

1. An electronic apparatus connected to a plurality of external electronic apparatuses through a network, the apparatus comprising:
a main power supply unit to supply direct current (DC) electric power to at least a portion of the electronic apparatus when the main power supply unit is supplied with alternating current (AC) electric power from a main power source;
a supplementary power source provided with a charger that is charged with the DC electric power supplied from the main power supply unit when the supplementary power source is in a charging state, and to supply charged electric power from the charger to at least the portion of the electronic apparatus when the supplementary power source is in a discharging state;
an interface to transmit or receive electric power to or from at least one of the plurality of external electronic apparatuses through the network; and
a controller that controls the interface to selectively (1) transmit electric power from the electronic apparatus to a first selected external electronic apparatus through the network so as to charge an external supplementary power source provided in the first selected external electronic apparatus, and (2) receive electric power from a second selected electronic apparatus through the network so as to charge the supplementary power source of the electronic apparatus.

2. The electronic apparatus of claim 1, wherein:
the controller controls the interface to transmit electric power from the electronic apparatus to the first selected external electronic apparatus through the network, when at least one of conditions is satisfied, the conditions including:
a condition in which the electronic apparatus operates under an operation mode in which electric power is supplied from the main power source through the main power supply unit; and
a condition in which the supplementary power source of the electronic apparatus has a remaining operation time period that is equal to or greater than a predetermined value.

3. The electronic apparatus of claim 2, wherein:
the controller determines whether any one of the plurality of external electronic apparatuses operates under an operation mode in which electric power is not supplied from the main power source through the main power supply unit, and selects at least one of the plurality of external electronic apparatuses that operates under the operation mode in which electric power is not supplied from the main power source, as the first selected external electronic apparatus.

4. The electronic apparatus of claim 3, wherein:
the controller further obtains information regarding a charger of an external supplementary power source for each one of the plurality of external electronic apparatuses, and selects at least one of the plurality of external electronic apparatuses having the external supplementary power source with a remaining operation time period that is less than a predetermined value, as the first selected external electronic apparatus.

5. The electronic apparatus of claim 4, wherein:
the controller further obtains conversion efficiency information indicating an AC/DC conversion efficiency of the main power supply unit for each one of the plurality of external electronic apparatuses, and selects at least one of the plurality of external electronic apparatuses having the AC/DC conversion efficiency that is lower than an AC/DC conversion efficiency of the main power supply unit of the electronic apparatus, as the first selected external electronic apparatus.

6. The electronic apparatus of claim 5, wherein:
the controller further obtains information indicating whether the external electronic apparatus is permitted to be charged with electric power received through the network, and selects at least one of the plurality of external electronic apparatuses that is permitted to be charged with electric power supplied through the network, as the first selected external electronic apparatus.

7. The electronic apparatus of claim 6, wherein:
the controller further obtains information used for identifying a destination electronic apparatus that is previously set to receive electric power transmitted from the external electronic apparatus, for each one of the plurality of external electronic apparatuses, and selects at least one of the plurality of external electronic apparatuses that is previously set as a destination electronic apparatus for the electronic apparatus, as the first selected external electronic apparatus.

8. The electronic apparatus of claim 4, wherein the information regarding the charger of the external supplementary power source includes at least one of:
information indicating a charge level of the charger of the supplementary power source;
information indicating an operation time period in which the charger of the supplementary power source has been operating in the discharging state; and
information indicating a remaining operation time period in which the charger of the supplementary power source will operate in the discharging state.

9. The electronic apparatus of claim 2, wherein:
the controller determines whether any one of the plurality of external electronic apparatuses operates under the operation mode in which electric power is supplied from the main power source through a main power supply unit, and selects at least one of the plurality of external electronic apparatuses that operates under the operation mode in which electric power is supplied from the main power source, as the second selected external electronic apparatus.

10. The electronic apparatus of claim 9, wherein:
the controller further obtains information regarding a charger of an external supplementary power source for each one of the plurality of external electronic apparatuses, and selects at least one of the plurality of external electronic apparatuses having a remaining operation time period of the external supplementary power source that is equal to or greater than a predetermined value, as the second selected external electronic apparatus.

11. The electronic apparatus of claim 10, wherein:
the controller further obtains conversion efficiency information indicating an AC/DC conversion efficiency of the main power supply unit for each one of the plurality of external electronic apparatuses, and selects at least one of the plurality of external electronic apparatuses having the AD/DC conversion efficiency that is greater than an AC/DC conversion efficiency of the main power supply unit of the electronic apparatus, as the second selected external electronic apparatus.

12. An electronic power supply control system, the system comprising:
a plurality of electronic apparatuses connected through a network, wherein a first electronic apparatus of the plurality of electronic apparatuses includes:
a main power supply unit to supply electric power to at least a portion of the first electronic apparatus when the main power supply unit is supplied with electric power from a main power source;
a supplementary power source provided with a charger that is charged with the electric power supplied from the main power supply unit when the supplementary power source is in a charging state, and to supply charged electric power from the charger to at least the portion of the first electronic apparatus when the supplementary power source is in a discharging state;
an interface to transmit or receive electric power to or from an external electronic apparatus through the network, the external electronic apparatus being any one of the plurality of electronic apparatuses other than the first electronic apparatus; and
a controller that controls the interface to selectively (1) transmit electric power from the first electronic apparatus to a first selected external electronic apparatus through the network so as to charge an external supplementary power source provided in the first selected external electronic apparatus, and (2) receive electric power from a second selected electronic apparatus through the network so as to charge the supplementary power source of the first electronic apparatus.

13. The system of claim 12, wherein the first electronic apparatus is an image forming apparatus that forms an image on a recording sheet.

14. A method of controlling electric power supply with respect to a plurality of external electronic apparatuses connected through a network, performed by an electronic apparatus provided with a main power supply unit, a supplementary power source, and an interface, the method comprising:
determining whether the supplementary power source of the electronic apparatus has a remaining operation time period that is equal to or greater than a predetermined value to generate a first determination result;
causing the interface to transmit electric power from the electronic apparatus to a first selected external electronic apparatus through the network so as to charge an external supplementary power source provided in the first selected external electronic apparatus, when the first determination result indicates that the supplementary power source of the electronic apparatus has the remaining operation time period that is equal to or greater than the predetermined value; and
causing the interface to receive electronic power from a second selected electronic apparatus through the network so as to charge the supplementary power source provided in the electronic apparatus, when the first determination result indicates that the supplementary power source of the electronic apparatus has the remaining operation time period that is less than the predetermined value.

15. The method of claim 14, further comprising:
determining whether any one of the plurality of external electronic apparatuses operates under an operation mode in which electric power is not supplied from a main power source through a main power supply unit;
selecting at least one of the plurality of external electronic apparatuses that operates under the operation mode in which electric power is not supplied from the main power source, as the first selected external electronic apparatus;
determining whether the electronic apparatus operates under an operation mode in which electric power is supplied from the main power source through the main power supply unit to generate a second determination result; and
causing the interface to transmit electric power from the electronic apparatus to the first selected external electronic apparatus through the network, when the second determination result indicates that the electronic apparatus operates under the operation mode in which electric power is supplied from the main power source, even when the first determination result indicates that the supplementary power source of the electronic apparatus has the remaining operation time period that is less than the predetermined value.

16. The method of claim 15, wherein when the first selected external electronic apparatus includes more than one external electronic apparatus, the method further comprising:
obtaining information regarding a charger of an external supplementary power source for each one of the plurality of external electronic apparatuses; and
selecting at least one of the plurality of external electronic apparatuses having the external supplementary power source with the least remaining operation time period, as the first selected external electronic apparatus.

17. The method of claim 15, wherein when none of the plurality of external electronic apparatuses and the electronic apparatus operates under the operation mode in which electric power is not supplied from the main power source, the method further comprising:
obtaining conversion efficiency information indicating an AC/DC conversion efficiency of the main power supply unit for each one of the plurality of external electronic apparatuses; and
selecting at least one of the plurality of external electronic apparatuses having a conversion efficiency that is lower than an AC/DC conversion efficiency of the main power supply unit of the electronic apparatus, as the first selected external electronic apparatus.
